(19) United States
(12) Patent Application Publication
(10) Pub. No.: US 2005/0128899 A1
(43) Pub. Date: Jun. 16, 2005

(54) Disk player

(75) Inventors: Takeshi Kamemura, Osaka (JP); Tadashi Uchiyama, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: SANYO ELECTRIC CO. LTD., Moriguchi-shi (JP); SANYO TECHNOSOUND CO., LTD., Daito-shi (JP)

(21) Appl. No.: 11/008,189

(22) Filed: Dec. 10, 2004

(30) Foreign Application Priority Data
Dec. 11, 2003 (JP) 2003-412646

(51) Int. Cl. G11B 7/00

(52) U.S. Cl. 369/44.28; 369/44.14

(57) ABSTRACT

The present invention provides a disk player which includes a switch for detecting that a pickup is positioned for reading signals as opposed to the middle position between a content signal recording area and a reference information recording area. The pickup is moved to an inner periphery of the disk for a predetermined period of time from the time of detection detected by the switch, upon a command given to read information from the reference information recording area. Then the pickup is restrained from moving further by a stopper, upon the pickup reaching the position opposed to the reference information recording area.

### BACKGROUND OF THE INVENTION

1. Field of the Invention

The present invention relates to disk players for reading signals from disk-shaped recording medium, such as optical disks, etc., to reproduce voice and/or image.

2. Description of the Related Art

A disk player comprises a turntable for rotatingly driving a disk, a pickup for reading signals from the rotating disk, and a pickup drive device for reciprocatingly driving the pickup radially of the disk by mesh between a rack and a pinion, to read optically the signals from a signal bearing surface of the disk.

With reference to FIG. 14, a disk D has a signal bearing surface provided thereon with a recording area A of audio signals and video signals, and provided in an inner periphery portion of the area A with a TOC (Table of Contents) area B for writing therein addresses of all trucks on the disk. A pickup reciprocatingly moves radially of the disk within these recording areas (content signal recording area) to read the signals.

A pickup drive device of the conventional disk player, as shown in FIG. 13, includes a pickup 4 to be guided so as to reciprocatingly move radially of the disk, a rack 5 attached to the pickup 4, and a pinion 73 in mesh with the rack 5 and to be turnably driven by a motor (not shown). Further, the disk player includes a switch 74 to be turned on when the pickup 4 moves to an inner peripheral side of the disk through the content signal recording area, and a stopper 76 for receiving the rack 5 at a moving end on the inner peripheral side of the disk, whereby the pickup 4 is prevented from moving further inwardly of the disk beyond the TOC recording area.

In order to control positions of the pickup 4 with high accuracy, backlash between the rack 5 and the pinion 73 is required to be zero. Accordingly with the pickup drive device shown in FIG. 13, the rack 5 is attached to the pickup 4 by a spring piece 50, whereby the rack 5 is pressed onto the pinion 73 at all times by biasing force of the spring piece 50 (JP-A-63213/1997).

With the disk player including the pickup drive device described, in the case where an excessive force acts on the rack 5 by an impact due to the disk player's falling, etc., the rack 5 is caused to be away from the pinion 73 against elastic force of the spring piece 50, releasing mesh between the rack 5 and the pinion 73, to thereby prevent damage to teeth.

In recent years, optical disks have a reference information recording area C termed BCA (Burst Cutting Area) or a barcode area arranged on a further inner periphery from the TOC area B on the signal bearing surface, as shown in FIG. 14. The pickup 4 reads reference information from the reference information recording area C to thereby make it possible to obtain various information services, for example. In order to correspond to such an optical disk as has the reference information recording area, the switch 74 and the stopper 76 provided with the disk player shown in FIG. 13 are relocated to the inner peripheray of the disk to allow the pickup 4 to read information from the reference information recording area.

The content signal recording areas A and B are, however, different from the reference information recording area C in recording format of signals or information. Therefore, the control of movement of the pickup 4 in the content signal recording area, as it is, cannot be applied to the control of movement in the reference information recording area. Even if the pickup 4 is kept moving until the switch 74 is turned on, inertial force of the pickup 4 causes the rack 5 to bump the stopper 76, to shift the position of mesh between the rack 5 and the pinion 73 due to the bump reaction, retreating the rack 5 by one to several pitches of tooth profile, whereby there is a likelihood that the pickup 4 is shifted from the reference information recording area C for reading signals. Furthermore, this also gives rise to the problem of noise involved in the repetition of tooth skip of the rack 5 and the pinion 73.

### SUMMARY OF THE INVENTION

An object of the present invention is to provide a disk player which is adapted to read both content signals and reference information from a disk having a reference information recording area provided on an inner periphery of a content signal recording area of a signal bearing surface thereof.

Another object of the present invention is to provide a disk player free of likelihood of noise produced in reading the reference information.

A disk player embodying the present invention comprises a turntable 9 for rotatingly driving a disk, a pickup 4 for reading signals from the rotating disk, a pickup drive device 7 for reciprocatingly driving radially of the disk the pickup 4 between a content signal recording area and a reference information recording area by mesh between a rack 5 and a pinion 73, a mesh release mechanism 3 for releasing the mesh between the rack 5 and the pinion 73 upon exertion of an excessive force on the rack 5, detection means for detecting that the pickup 4 is positioned for reading signals as opposed to the middle position between the content signal recording area and the reference information recording area, drive control means for, upon a command given to read information from the reference information recording area, operating the pickup drive device 7 for a predetermined period of time from the time of detection by the detection means to move the pickup 4 toward an inner periphery of the disk, and a stopper 61 for restraining the pickup 4 from moving further upon the pickup 4 reaching a position for reading signals from the reference information recording area of the disk.

The disk player embodying the present invention further comprises a mesh release control mechanism 6 for controlling the operation of the mesh release mechanism 3 with the pickup 4 restrained from moving by the stopper 61.

With the disk player of the present invention, when a command is given to read signals from the content signal recording area of the disk, the pickup 4 is caused to move toward the inner periphery of the disk by the operation of the pickup drive device 7. Thereafter the detection means detects that the pickup 4 is positioned for reading signals as opposed to the middle position between the content signal recording area and the reference information recording area, whereupon the pickup drive device 7 ceases to operate, or is operated in a reverse direction for a predetermined period of time, followed by reading signals from the content signal recording area.

On the other hand, when a command is given to read information from the reference information recording area of the disk, the pickup 4 is caused to move toward the inner periphery of the disk by the operation of the pickup drive device 7. Thereafter the detection means detects that the pickup 4 is positioned for reading signals as opposed to the middle position between the content signal recording area and the reference information recording area, whereupon the pickup drive device 7 is further operated in the same direction for a predetermined period of time from the time of the detection, moving the pickup 4 toward the inner periphery of the disk. In this case the predetermined period of time is set longer than a period of time required for moving the pickup 4 toward the inner periphery of the disk until the pickup 4 is restrained from moving by the stopper 61.

As a result, the further movement of the pickup 4 is restrained by the stopper 61, to hold the pickup 4 at the position for reading signals from the reference information recording area. On this occasion, even if a great impact acts on the pickup 4 to exert thereon a force in a direction for operating the mesh release mechanism 3, the mesh release control mechanism 6 controls the operation of the mesh release mechanism 3, obviating the likelihood of release of mesh between the rack 5 and the pinion 73 with ease. Accordingly, noise involved in the repetition of tooth skip of the rack 5 and pinion 73 is unlikely to be produced.

In the case where an excessive force is exerted on the rack 5 due to an impact caused by disk player's falling, etc. with the pickup 4 positioned for reading signals from the content signal recording area, the mesh release mechanism 3 is operated to release the mesh between the rack 5 and the pinion 73, to thereby prevent the damage to the teeth.

Stated specifically, the mesh release mechanism 3 supports the rack 5 on a base 40 of the pickup 4 such that the rack 5 is allowed to be away from the pinion 73, and elastically biases the rack 5 toward the pinion 73. According to the specific construction, the mesh release mechanism 3 presses the rack 5 against the pinion 73, and backlash is therefore zero. Furthermore, when an impact force is exerted on the pickup 4, the rack 5 is away from the pinion 73 against elastic biasing force, to release the mesh therebetween, whereby the damage to the teeth is prevented.

Stated further specifically, the mesh release control mechanism 6 is in engagement with an end portion of the rack 5 adjacent to the inner periphery when the pickup 4 is restrained from moving by the stopper 61, to prevent the end portion from being away from the pinion 73. According to the specific construction, when a great impact force is exerted on the pickup 4, the rack 5 is elastically deformed with the end portion adjacent the inner periphery of the disk serving as a fixed end, resulting in release of the mesh between the rack 5 and the pinion 73, whereby damage to the teeth is precluded.

Stated still further specifically, the drive control means reduces a drive voltage in moving the pickup 4 to the reference information recording area of the disk, for a predetermined period of time from the detection by the detection means, which voltage is lower than a voltage in reciprocatingly moving the pickup 4 within the content signal recording area. According to the specific construction, the pickup 4 moves toward the reference information recording area of the disk with a decreased speed, to reduce the impact force when the movement of the pickup 4 is restrained by the stopper 61, lowering stress applied on the teeth face of the rack 5, whereby the pickup drive device 7 is given a prolonged life.

As described above, the disk player of the present invention is adapted to read both the content signals and the reference information from the disk having the reference information recording area provided on an inner periphery of the content signal recording area of the signal bearing surface thereof. Furthermore there is no likelihood of noise produced in reading the reference information.

### BRIEF DESCRIPTION OF THE DRAWINGS

FIG. 1 is a perspective view showing a pickup drive system of a disk player embodying the present invention;

FIG. 2 is an exploded perspective view of a pickup and a rack;

FIG. 3 is a perspective view of the pickup and the rack in an assembled state;

FIG. 4 is a perspective view of a state wherein a spring member is assembled into the rack;

FIG. 5 is a perspective view of the spring member;

FIG. 6 is a bottom view of the pickup drive system;

FIG. 7 is a perspective view of the pickup drive system as seen from the bottom side;

FIG. 8 is a bottom view of the pickup drive system in a state wherein the pickup reaches a moving end on an inner periphery of the disk;

FIG. 9 is a perspective view of the pickup drive system as seen from the bottom side;

FIG. 10 is a flow chart illustrating a control procedure of a pickup drive device;

FIG. 11 is a time chart illustrating control of the pickup drive device in reading the content signals;

FIG. 12 is a time chart illustrating control of the pickup drive device in reading a barcode area;

FIG. 13 is a plan view of a pickup drive system of the conventional disk player;

FIG. 14 is a plan view showing a plurality of recording areas provided on a signal bearing surface of the disk.

### DETAILED DESCRIPTION OF THE INVENTION

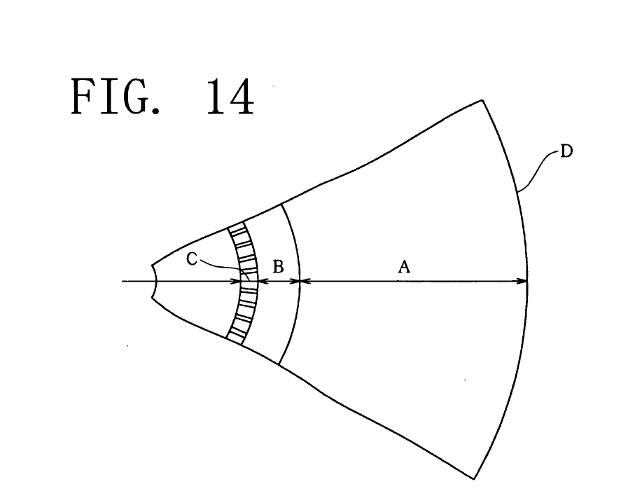

With reference to the drawings, modes for embodiment of the present invention will be described below. As shown in FIG. 14, a signal bearing surface of a disk D is provided thereon with a recording area A of audio and video signals (AV signals). An inner periphery of the area A is provided thereon with a TOC (Table of contents) area B for writing therein addresses of all trucks on the disk. Provided on further inner periphery of these recording areas (content signal recording area) is a barcode area C serving as a reference information recording area.

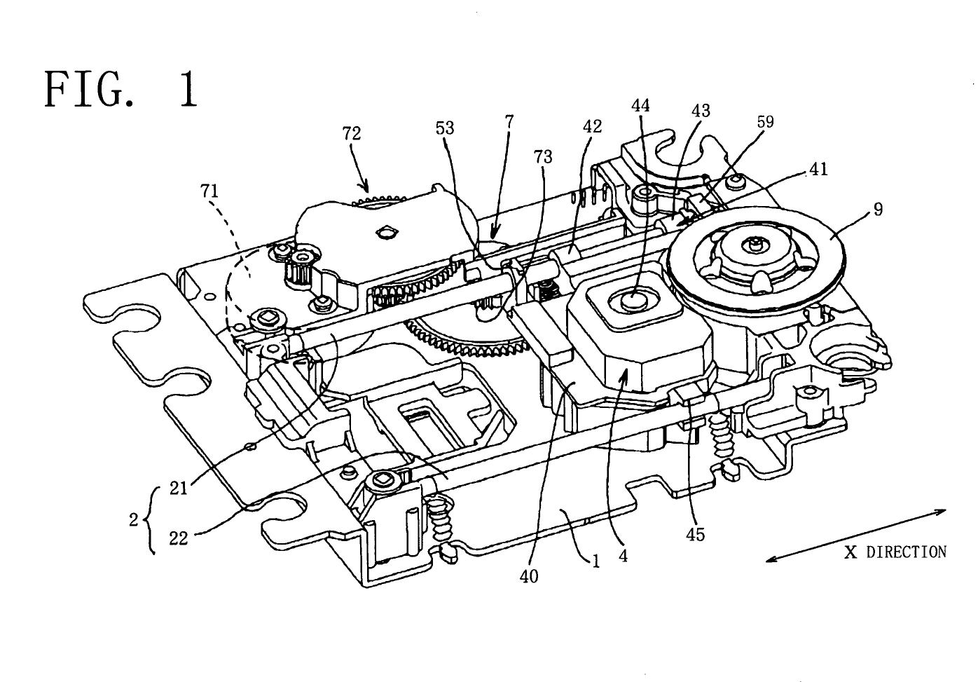

A disk player embodying the present invention comprises, as shown in FIG. 1, a turntable 9 for rotatingly driving a disk, a pickup 4 for reading signals from the rotating disk, a pickup drive device 7 for reciprocatingly driving the pickup 4 radially of the disk from the AV signal recording area to the barcode area through the TOC area, each of which are arranged on the chassis 1.

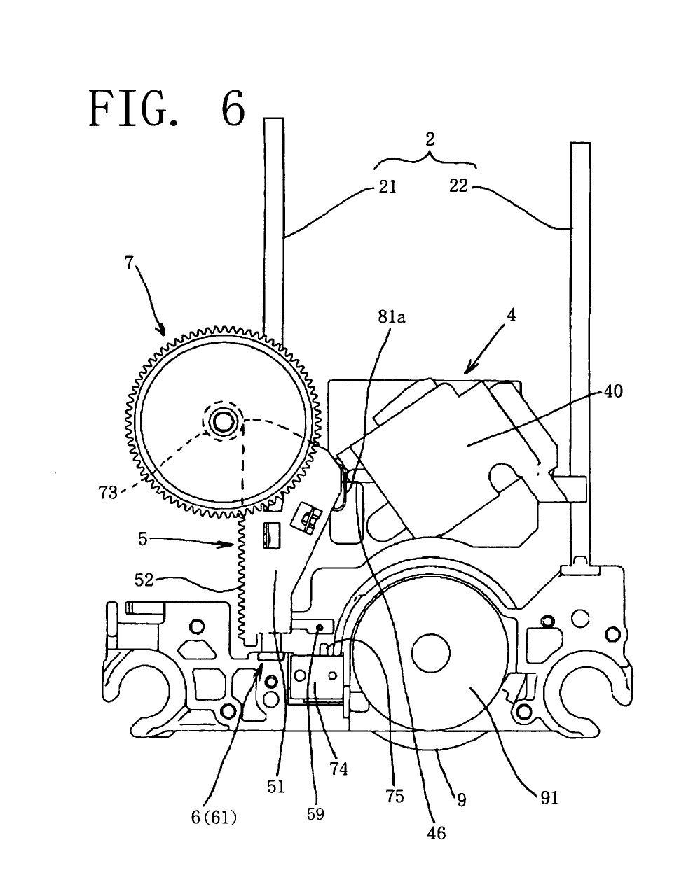

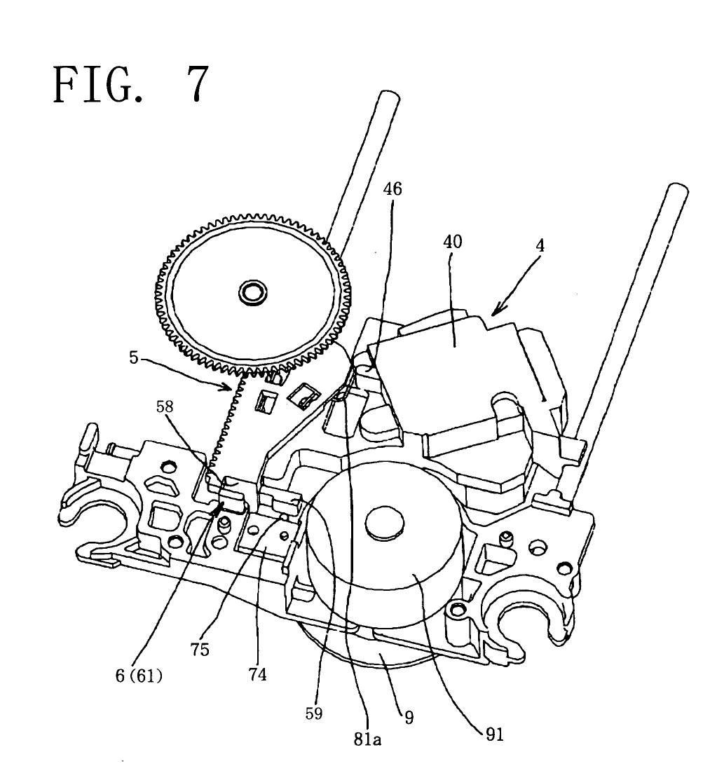

The pickup 4 has an objective lens 44 mounted on a base 40. The pickup 4 is reciprocatingly movably supported along a disk radial line by a guide member 2 including two parallel rails of a first rail 21 and a second rail 22 which are provided on the chassis 1. As shown in FIG. 6 and FIG. 7, the turntable 9 is coupled to a turntable drive motor 91 disposed on the rear surface of the chassis 1.

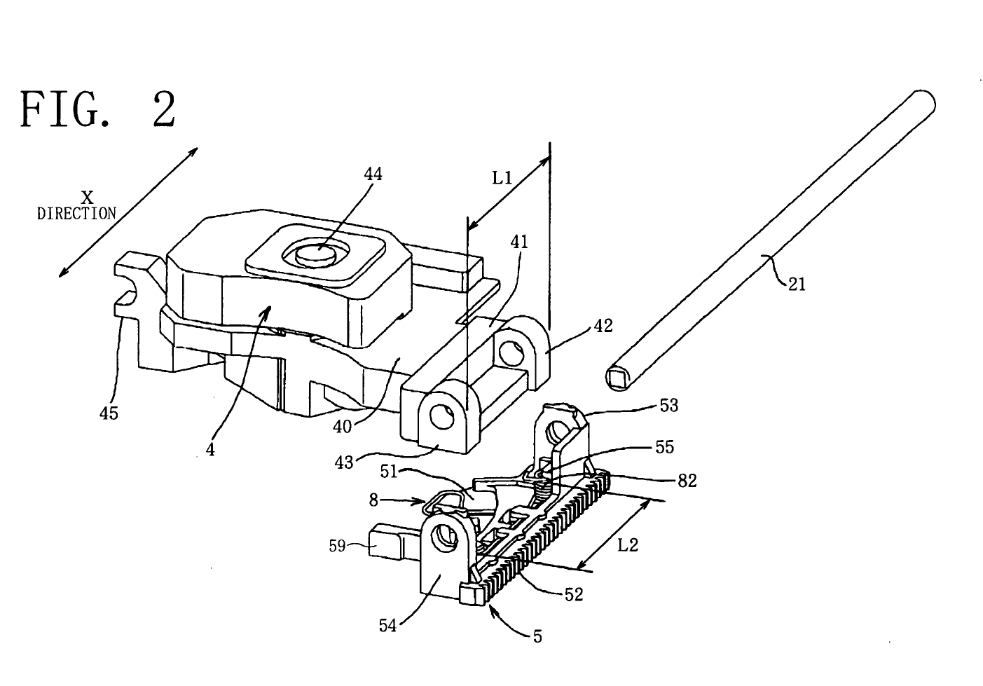

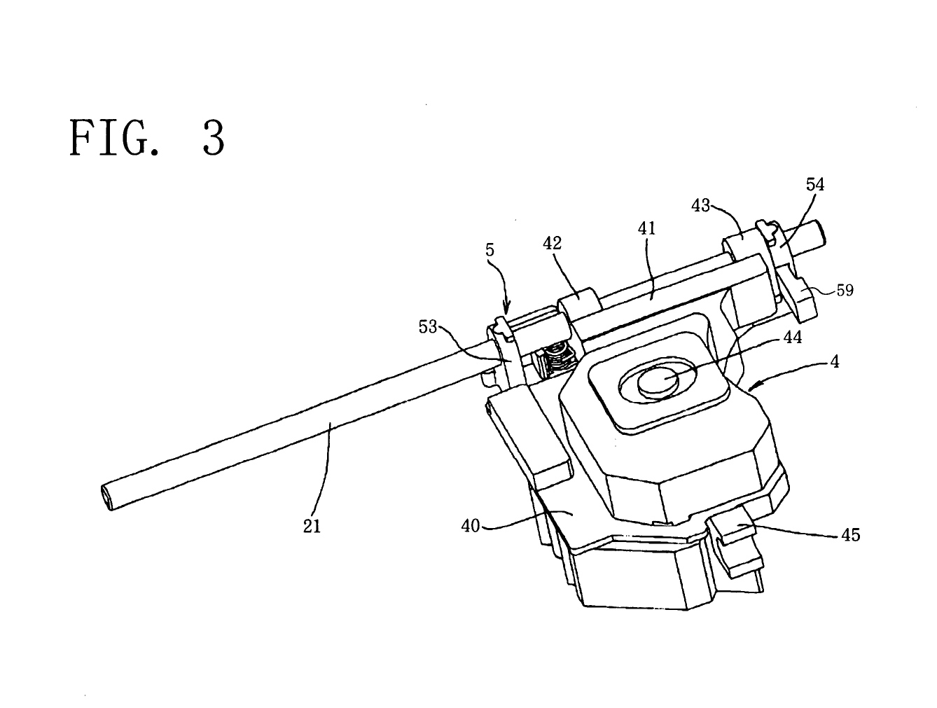

With reference to FIG. 2, the base 40 of the pickup 4 has attaching portions 41, 45 for attaching thereto the rails 21, 22 which portions are provided at opposite ends in a direction orthogonal to a direction of movement (indicated by an X arrow). One attaching portion 41 has attaching pieces 42, 43 provided at opposite ends thereof. The first rail 21 extends through the attaching pieces 42, 43. The other attaching portion 45 is slidably engaged with the second rail 22.

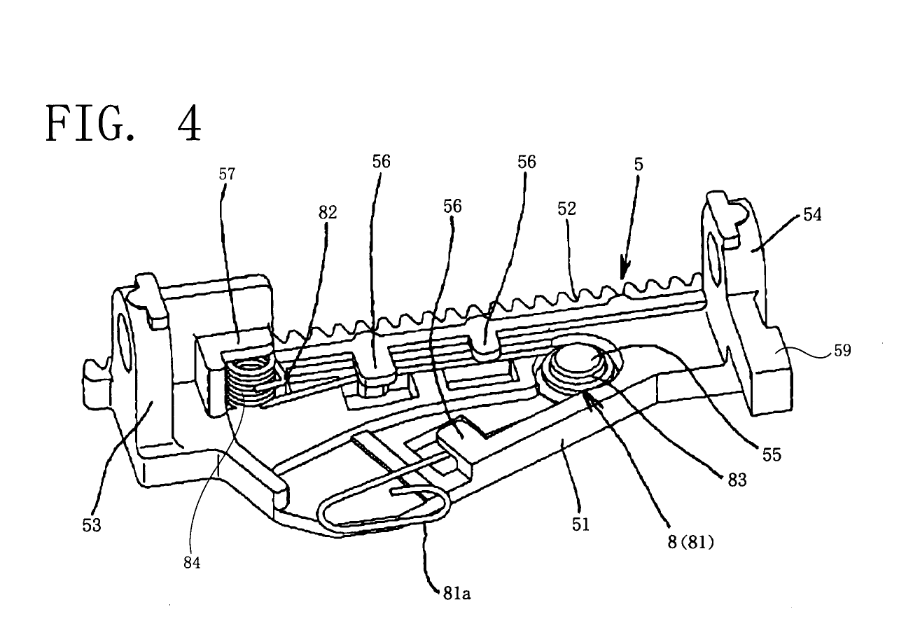

The base 40 has a rack 5 extending in a direction of movement of the pickup 4 and provided at an end portion adjacent to the attaching portion 41 of the first rail 21. As shown in FIG. 2 and FIG. 4, the rack 5 has a rack face 52 formed on a side edge longitudinally of a spring attaching portion 51 for attaching thereto a spring member 8 to be described below. A pair of support pieces 53, 54 is provided in the vicinity of opposite end portions of the rack face 52. The first rail 21 extends through the two support pieces 53, 54 of the rack 5. The attaching portion 41 of the pickup 4 is fitted between the two support pieces 53, 54 of the rack 5 with a reserve in the direction of slide of the base 40. The rack 5 is turnable about the first rail 21.

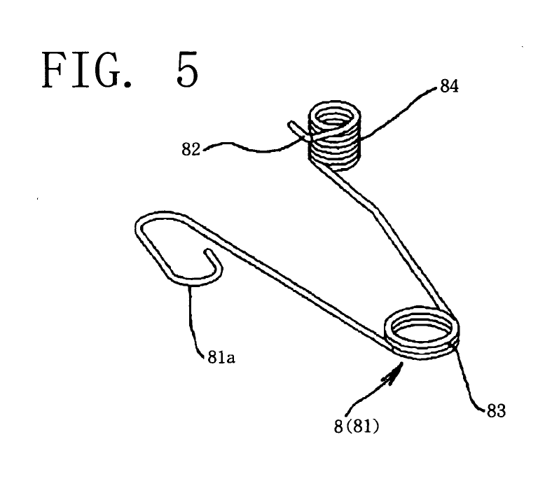

As shown in FIG. 1 and FIG. 6, the pickup drive device 7 comprises a motor 71, deceleration gear train 72 coupled to the motor 71, a pinion 73 positioned lowermost of the deceleration gear train 72 and to mesh with the rack face 52 of the rack 5. The spring member 8 is attached to the spring attaching portion 51 of the rack 5. As shown in FIG. 4 and FIG. 5, the spring member 8 is formed by bending one metal spring material into an approximately V-shape. The spring member 8 has one end contacted with a latch portion 57 provided adjacent the support piece 53 on an inner peripheral side of the disk of the rack 5 while the member 8 has the other end contacted with the base 40 serving as the mating member as compressed.

The rack 5 is biased toward the pinion 73 by the reaction of the force of the spring member 8 for biasing the base 40, i.e., the entire spring member 8 in the approximately V-shape serves as a first biasing portion 81 for biasing the rack 5 toward the pinion 73. The rack 5 is turnably provided on the rail 21 to allow the rack 5 to be away from the pinion 73 while the rack 5 is biased toward the pinion 73 by the spring member 8, whereby a mesh release mechanism 3 is provided for releasing mesh between the rack 5 and the pinion 73. In the mechanism, when the excessive force is exerted on the rack 5, the rack 5 is away from the pinion 73 to release the mesh between gears thereof.

Formed at an end portion adjacent to the latch portion 57 of the spring member 8 is a second biasing portion 82 for biasing the base 40 in one direction (a movement direction of the outer periphery of the disk in the present embodiment) so as to prevent jarring between the base 40 and the rack 5. As shown in FIG. 2, spacing L2 between the second biasing portion 82 and an inner surface of the support piece 54 adjacent to the outer periphery of the disk is slightly narrower than spacing L1 between outer surfaces of the attaching pieces 42, 43 of the attaching portion 41 of the pickup 4. The second biasing portion 82 is stretched outwardly to fit the attaching portion 41 of the base 40 between the second biasing portion 82 and the support piece 54 adjacent the outer peripheral of the disk, thereby biasing the attaching piece 43 of the base 40 toward the support piece 54 to cause the attaching piece 43 to contact with the support piece 54 at all times. Incidentally the biasing force of the second biasing portion 82 has an amplitude such that the rack 5 turns about the rail 21 free of trouble.

Referring to FIG. 5, the spring member 8 is formed by spring steel wire. The V-shaped bent portion comprises a ring-shaped attaching portion 83 formed by concentrically winding the spring steel wire a plurality of turns, and a cylindrical portion 84 formed by concentrically winding the wire a plurality of turns at a side end of the second biasing portion 82. One end of the cylindrical portion 84 extends in an L-shape toward the ring-shaped attaching portion 83 to provide the second biasing portion 82. The other end of the spring member 8 is bent so as to be folded outwardly in an approximately J-shape, thereby forming a contact portion 81a with the base 40.

As shown in FIG. 4, the spring member 8 has the ring-shaped attaching portion 83 to be fitted around a circular boss 55 on the spring attaching portion 51 of the rack 5, and the cylindrical portion 84 to be fitted into the latch portion 57 on the rack 5 to thereby be latched. The rack 5 has retainer pieces 56 provided at a plurality of positions for covering a linear part of the spring member 8.

With reference to FIG. 6, the contact portion 81a of the spring member 8 is in contact with a receiving portion 46 formed on the base 40. As shown in FIG. 6 and FIG. 7, arranged on the chassis 1 are a switch 74 to be turned on when the pickup 4 is positioned for reading signals as opposed to the middle position between the TOC area and the barcode area of the disk, and a stopper 61 for restraining the further movement of the pickup 4 when the pickup 4 is positioned for reading information from the barcode area. A press piece 59 provided on the rack 5 presses an actuating piece 75, turning on the switch 74, to cutoff current supply to the motor 71 of the drive device 7, thereby ceasing the movement of the pickup 4.

When the pickup 4 is positioned for reading information from the barcode area, the stopper 61 serves also as a mechanism 6 for controlling mesh release to control the movement of the mesh release mechanism 3, i.e., a notch 58 engageable with the stopper 61 is provided on an end surface of the rack 5 on the inner periphery of the disk which surface is opposed to the rack face 52, causing an inner surface of the notch 58 facing the inner periphery of the disk to be in contact with the stopper 61, whereby the movement of the rack 5 is restrained.

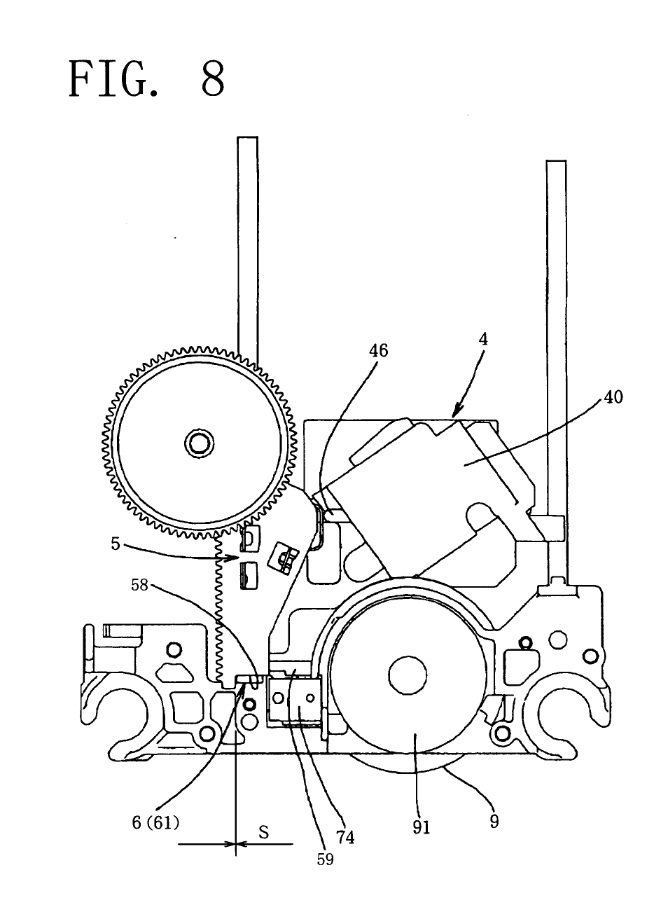

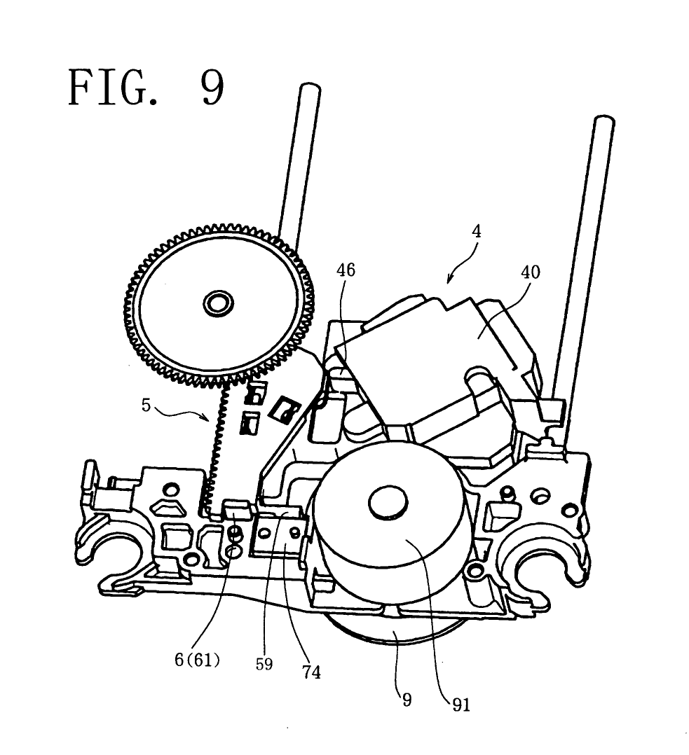

As shown in FIG. 8 and FIG. 9, when the stopper 61 is engaged with the notch 58, there merely exists a small clearance S between the face of the notch 58 opposed to the rack face 52 and the stopper 61 so as not to be in contact with the rack 5. Thus even if a great force acts on the rack 5 upon the pickup 4 reaching the position for reading information from the barcode area of the disk, the stopper 61 interrupts the turn of the rack 5 in a direction away from the pinion 73, to thereby prevent the release of mesh between the rack 5 and the pinion 73. However, when the pickup 4 is positioned for reading signals from the content signal recording area, a great impact acts onto the rack 5 by the player's falling, etc., to turn the rack 5 about the rail 21 by the operation of the mesh release mechanism 3, to release the mesh between the rack 5 and the pinion 73. This precludes the damage to teeth of the rack 5 and the pinion 73.

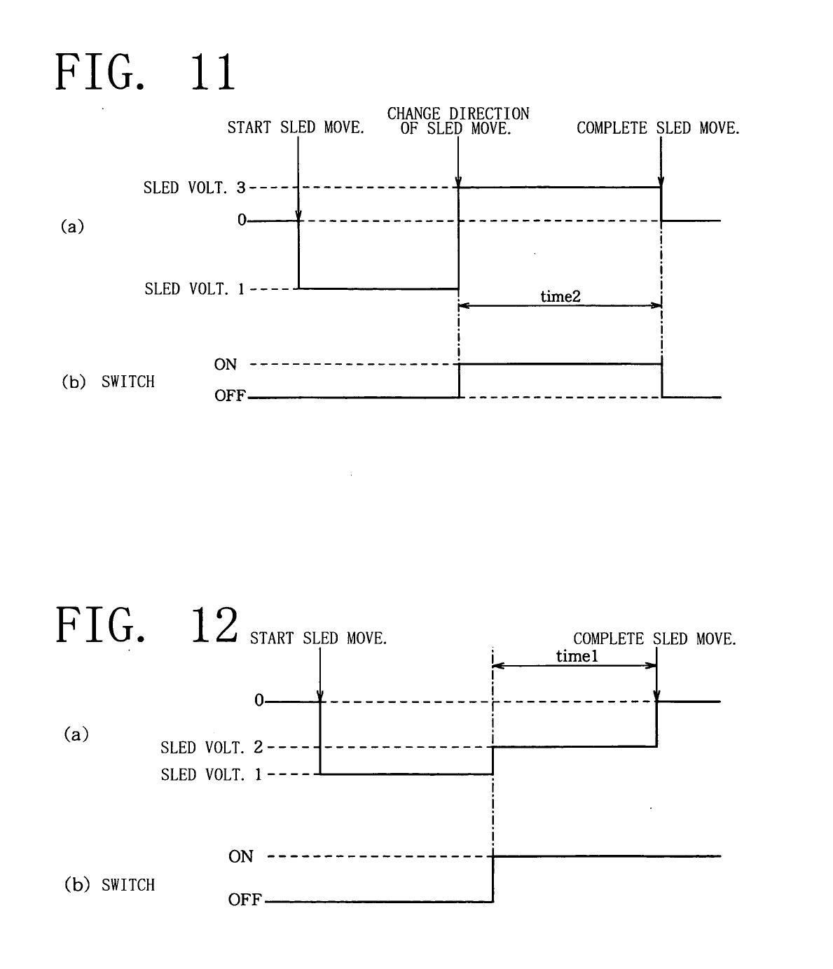

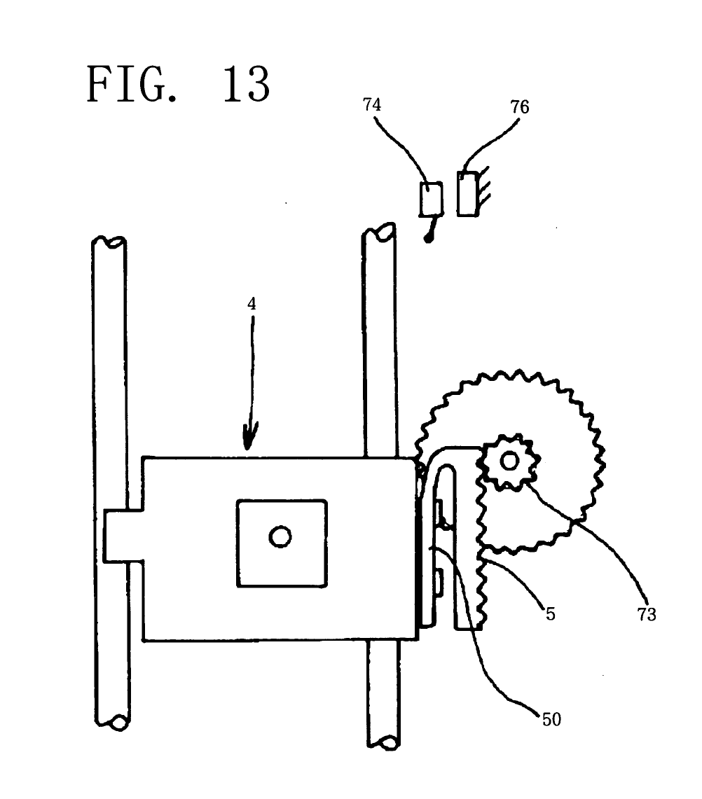

FIG. 11 shows control of the pickup drive device 7 when a command is given to read signals from the content signal recording area of the disk. FIG. 12 shows control of the pickup drive device 7 when a command is given to read information from the barcode area of the disk. Incidentally, “SLED movement” indicated in the illustrations means the radial movement of the pickup while “SLED voltage” means voltage to be applied on the pickup drive device 7.

When a command is given to read signals from the content signal recording area of the disk, first SLED voltage 1 is applied on the pickup drive device, as shown in FIG. 11, to move the pickup toward the inner periphery of the disk. The switch is thereafter turned on to detect that the pickup is positioned for reading signals as opposed to the middle position between the TOC area and the barcode area, whereupon SLED voltage 3 is applied on the pickup drive device for a predetermined period of time from the time of the detection (time 2), thereby moving the pickup in a reverse direction (in a direction of outer periphery of the disk), followed by reading the signals from the content signal recording area.

On the other hand, when a command is given to read information from the barcode area of the disk, first SLED voltage 1 is applied on the pickup drive device to move the pickup toward the inner periphery of the disk, as shown in FIG. 12. The switch is thereafter turned on to detect that the pickup is positioned for reading information as opposed to the middle position between the TOC area and the barcode area, whereupon drive voltage for the pickup drive device is reduced to SLED voltage 2, holding the SLED voltage 2 for a given period of time (time 1), to move the pickup further in the same direction (in a direction of the inner periphery of the disk). Thus the pickup reaches a position opposed to the barcode area of the disk simultaneously when the pickup is restrained from further moving by the stopper. This causes the pickup to read a barcode from the barcode area. Incidentally the SLED voltage 2 can be set to the same voltage as the SLED voltage 1 depending on the conditions.

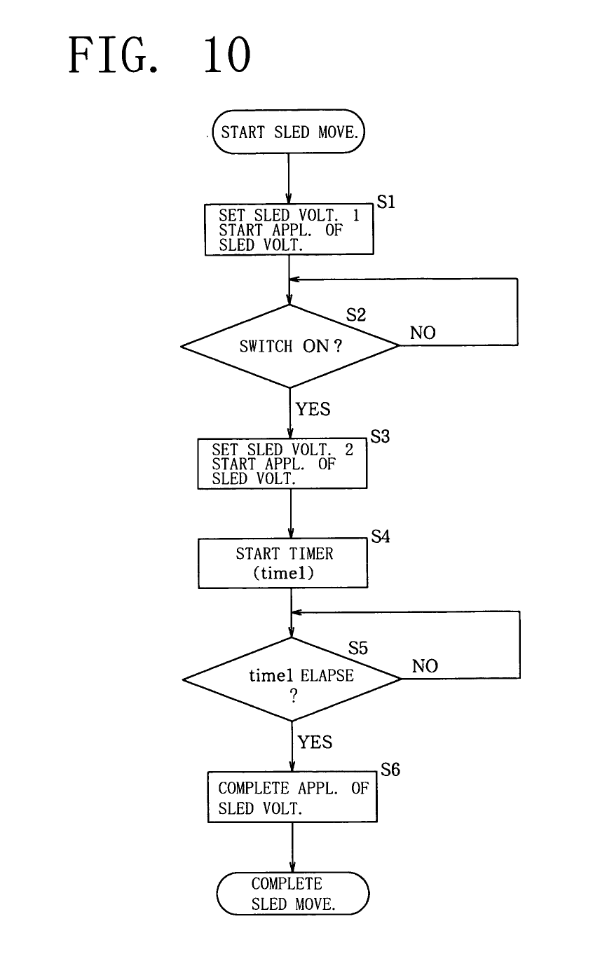

FIG. 10 illustrates the control procedure when a command is given to read information from the reference information recording area of the disk. First in step S1 SLED voltage 1 is set to apply the voltage on the pickup drive device. Subsequently in step S2 an inquiry is made as to whether the switch is turned on. When the answer to the inquiry of step S2 is affirmative, step S3 follows to set SLED voltage 2 to apply the voltage on the pickup drive device. In step S4 a timer is started, and then step S5 follows to inquire whether the time 1 has elapsed. When the answer to the inquiry of step S5 is affirmative, step S6 follows to complete the application of the SLED voltage.

By the execution of the control procedure described, the pickup moves from the position opposed to the content signal recording area of the disk toward the inner periphery of the disk at a relatively rapid speed, and is positioned as opposed to the middle position between the TOC area and the barcode area. The pickup thereafter moves further toward the inner periphery of the disk at a relatively slow speed, and reaches the position opposed to the barcode area. In this case, the rack 5 bumps the stopper 61, but the reduced moving speed as described will not produce the great impact force to reduce stress applied on teeth face of the rack 5. Consequently the pickup drive device 7 is given a prolonged life.

With the disk player embodying the present invention, as described above, when the pickup 4 is positioned as opposed to the barcode area of the disk, mesh between the rack 5 and the pinion 73 is not easily released owing to the operation of the mechanism 6 for controlling mesh release, so that unlike the conventional one, there is no likelihood of the problem of noise involved in teeth skip caused by releasing the mesh between the rack and the pinion due to the reaction when the pickup 4 bumps the stopper by inertia.

Furthermore, when the pickup is positioned as opposed to the barcode area of the disk, in the case where a great impact is produced by the player's falling, etc., free turn of the rack 5 is interrupted while the distance between a latch portion created by the stopper 61 of the rack 5 and the mesh portion thereof with the pinion 73 becomes great, so that the rack 5 is elastically deformed in a twisted direction with the latch portion created by the stopper 61 serving as a fixed end, resulting in release of the mesh between the rack 5 and the pinion 73, whereby damage to the teeth is precluded.

Further, in the case where force of mesh between the rack 5 and the pinion 73 is set moderately high in the operation of the mesh release mechanism 3, teeth skip of the rack 5 and the pinion 73 can be prevented even though drive voltage of the pickup drive device 7 is set to a high value to some extent in moving the pickup 4 to the position opposed to the barcode area. Thus the values of the drive voltage to be applied on the pickup drive device 7 can be in the broader range.

The device of the invention is not limited to the foregoing embodiment in construction but can be modified variously by one skilled in the art without departing from the spirit of the invention as set forth in the appended claims.

1. A disk player comprising a turntable 9 for rotatingly driving a disk having a reference information recording area provided on an inner periphery of a content signal recording area, a pickup 4 for reading signals from the rotating disk, a pickup drive device 7 for reciprocatingly driving radially of the disk the pickup 4 between the content signal recording area and the reference information recording area by mesh between a rack 5 and a pinion 73, and a mesh release mechanism 3 for releasing the mesh between the rack 5 and the pinion 73 upon exertion of an excessive force on the rack 5, the disk player comprising:
detection means for detecting that the pickup 4 is positioned for reading signals as opposed to the middle position between the content signal recording area and the reference information recording area,
drive control means for, upon a command given to read information from the reference information recording area, operating the pickup drive device 7 for a predetermined period of time from the time of detection by the detection means to move the pickup 4 toward an inner periphery of the disk, and
a stopper 61 for restraining the pickup 4 from moving further upon the pickup 4 reaching a position for reading signals from the reference information recording area of the disk.

2. A disk player according to claim 1 which further comprises a mesh release control mechanism 6 for controlling the operation of the mesh release mechanism 3 with the pickup 4 restrained from moving by the stopper 61.

3. A disk player according to claim 1 wherein the mesh release mechanism 3 supports the rack 5 on a base 40 of the pickup 4 such that the rack 5 is allowed to be away from the pinion 73, and elastically biases the rack 5 toward the pinion 73.

4. A disk player according to claim 2 wherein the mesh release control mechanism 6 is in engagement with an end portion of the rack 5 adjacent the inner periphery of the disk with the pickup 4 restrained from moving by the stopper 61, to prevent the end portion from being away from the pinion 73.

5. A disk player according to claim 1 wherein the drive control means reduces a drive voltage in moving the pickup 4 to the reference information recording area of the disk, for a predetermined period of time from the detection by the detection means, which voltage is lower than a voltage in reciprocatingly moving the pickup 4 within the content signal recording area.

6. A disk player according to claim 1 wherein the predetermined period of time is set longer than a period of time required for moving the pickup 4 toward the inner periphery of the disk until the pickup 4 is restrained from moving by the stopper 61.

7. A disk player comprising a turntable 9 for rotatingly driving a disk having a reference information recording area provided on an inner periphery of a content signal recording area, a pickup 4 for reading signals from the rotating disk, a pickup drive device 7 for reciprocatingly driving radially of the disk the pickup 4 between the content signal recording area and the reference information recording area by mesh between a rack 5 and a pinion 73, and a mesh release mechanism 3 for releasing the mesh between the rack 5 and the pinion 73 upon exertion of an excessive force on the rack 5, the disk player comprising:
detection means for detecting that the pickup 4 is at a specified position for reading signals,
drive control means for, upon a command given to read information from the reference information recording area, operating the pickup drive device 7 for a predetermined period of time from the time of detection by the detection means to move the pickup 4 toward an inner periphery of the disk, and
a stopper 61 for restraining the pickup 4 from moving to an inner periphery of the disk.

8. A disk player according to claim 7 which further comprises a mesh release control mechanism 6 for controlling the operation of the mesh release mechanism 3 with the pickup 4 restrained from moving by the stopper 61.

9. A disk player according to claim 7 wherein the mesh release mechanism 3 supports the rack 5 on a base 40 of the pickup 4 such that the rack 5 is allowed to be away from the pinion 73, and elastically biases the rack 5 toward the pinion 73.

10. A disk player according to claim 8 wherein the mesh release control mechanism 6 is in engagement with an end portion of the rack 5 adjacent the inner periphery of the disk with the pickup 4 restrained from moving by the stopper 61, to prevent the end portion from being away from the pinion 73.

11. A disk player according to claim 7 wherein the drive control means reduces a drive voltage in moving the pickup 4 to the inner periphery of the disk, for a predetermined period of time from the detection by the detection means, which voltage is lower than a voltage in reciprocatingly moving the pickup 4 within the content signal recording area.

12. A disk player according to claim 7 wherein the predetermined period of time is set longer than a period of time required for moving the pickup 4 toward the inner periphery of the disk until the pickup 4 is restrained from moving by the stopper 61.
